(19) United States
(12) Patent Application Publication
(10) Pub. No.: US 2011/0227438 A1
(43) Pub. Date: Sep. 22, 2011

(54) Self Generating Motor-Generator Assembly

(76) Inventor: Syed Z. Hassnain, New York, NY (US)

(21) Appl. No.: 12/724,970

(22) Filed: Mar. 16, 2010

(51) Int. Cl. H02K 47/14

(52) U.S. Cl. 310/113

(57) ABSTRACT

A self generating motor-generator assembly having a universal motor with AC input terminals and DC input terminals and a generator having a shaft mechanically coupled to the universal motor to generate a DC potential which is fed to the DC input terminals of the universal motor to cause the universal motor to rotate the generator shaft. A second motor which is mechanically coupled to the generator shaft is provide to increase the speed of the generator to its rated speed when the universal motor does not drive the shaft of the generator to rotate at its rated speed.

### BACKGROUND OF THE INVENTION

1. Field of the Invention

The present invention relates to an apparatus and method for generating electricity and more specifically to a motor-generator assembly which utilizes electrical power from the generator to operate the motor which is mechanically coupled to the generator.

2. Description of Related Art

Apparatus and methods for generating electrical power and providing motors for using electrical power is known in the prior art. More specifically, by way of example, U.S. PreGrant Publication No. 2004/0150289 to James discloses a universal motor/generator/alternator apparatus that comprises: at least one moveable body having multiple surfaces with a plurality of magnets or coils on each surface; multiple electrical conductor assemblies surrounding each moveable body where each electrical conductor is coplanar to a corresponding moveable element surface that contains the magnets; and means to either energize the electrical conductor in the electrical conductor assemblies to create magnetic fields that interact with the moveable body causing movement of the body; or to mechanically move the moveable body to induce an electric current in the electrical conductors in the electrical conductor assemblies.

U.S. Pat. No. 6,407,466 to Caamano discloses a device such as an electric motor, an electric generator, or a regenerative electric motor which includes a rotor arrangement and a stator arrangement. The stator arrangement has a dielectric electromagnet housing and at least one energizable electromagnet assembly including an overall amorphous metal magnetic core. The overall amorphous metal magnetic core is made up of a plurality of individually formed amorphous metal core pieces. The dielectric electromagnet housing has core piece openings formed into the electromagnet housing for holding the individually formed amorphous metal core pieces in positions adjacent to one another so as to form the overall amorphous metal magnetic core. The device further includes a control arrangement that is able to variably control the activation and deactivation of the electromagnet in order to control the speed, efficiency, torque, and power of the device.

U.S. Pat. No. 6,326,710 to Guenther, et al. discloses an electric motor having a switching device, a driving circuit connectable to a voltage supply through the switching device and having a drive shaft, a mechanically acting braking device for braking the drive shaft when disconnecting the electric motor from the voltage supply, a rotor serving to generate torque and acted upon by a mechanical braking force when switching off the voltage supply, at least one radially displaceable part which applies the braking force and is magnetizable and acted upon by an electromagnetic releasing force which is directed opposite to the braking force and is greater than the braking force, and a stator having an axial slit which is overlapped by the part, and at least one shorted turn arranged in an area of the slit.

U.S. Pat. No. 6,134,124 to Jungreis, et al. discloses an electronic interface that provides an efficient mechanism for integrating a variety of storage and generation devices to produce high quality power and reliability to a load as well as to facilitate interfacing of the storage and generation devices to the power grid for purposes of energy control, load leveling, and peak shaving.

U.S. Pat. No. 6,252,331 to Mildice, et al. discloses a rotating electrical machine which has a two-phase rotor with two non-rotating solenoid-wound rotor coil assemblies and two interleaved pole assemblies. Each pole assembly is magnetically coupled to its respective coil assembly and rotates together with the machine shaft. Each pole assembly has four or more elongated pole pieces, two of which couple with one pole of a coil assembly and two of which couple with the other pole of that coil assembly. An exciter circuit independently controls the power variables provided to the rotor with respect to the stator to provide a variable-speed, variable-frequency motor system or generator system. The exciter energizes the solenoid-wound rotor coils with biphase AC electrical excitation, to produce a radial, rotating magnetic field at the pole pieces.

U.S. Pat. No. 6,016,041 to Weinmann discloses a rotary speed control circuit for feeding a dc universal motor for driving a washing machine. A rectifier and a smoothing capacitor derive the operating voltage of the motor from the mains ac voltage and provided for control of the rotary speed is a regulating device which controls a power stage for the motor, the power stage including a power switch and a commutation diode in a low-setting device.

U.S. Pat. No. 5,959,387 to Mowery, et al. discloses a method for winding a field assembly for a universal motor. The method involves winding both a field winding and a brake winding over different field poles within a field core simultaneously. After the first field winding and the first brake winding are wound, the field core is indexed to allow a second brake winding to be wound over the first field winding, and a second field winding to be wound over the first brake winding. By using the disclosed method, a field assembly is produced in which both field windings and the brake windings are wound using one continuous wire for each.

U.S. Pat. No. 5,552,686 to Schmid, et al. discloses a series motor which has a braking device, a stator having a field winding and a pole shoe plate pack, where the pole shoe plate pack of the stator has field coils and a further element inducing a magnetic field, a rotatable armature, and an element for influencing a braking operation of the field winding.

U.S. Pat. No. 4,751,414 to Davis, et al. discloses a dynamic braking circuit for a universal motor. A switching mechanism is used to reverse the orientation of the series field winding with respect to the rotor when power is removed. Because the rotor acts as a generator when power is removed, it will generate current to the field winding. Because the orientation of the field winding has been reversed, the field winding will thus try to make the motor run in the opposite direction, thereby exerting a braking force on the motor. The amount of the braking force is limited by using a portion of a second winding to oppose the reversed action of the first winding.

### SUMMARY OF THE INVENTION

In an exemplary embodiment of the present invention, there is disclosed a self generating motor-generator assembly having a universal motor with AC input terminals and DC input terminals and a generator having a shaft mechanically coupled to the universal motor to generate a DC potential which is fed to the DC input terminals of the universal motor to cause the universal motor to rotate the generator shaft. A second motor which is mechanically coupled to the generator shaft is provide to increase the speed of the generator to its rated speed when the universal motor does not drive the shaft of the generator to rotate at its rated speed.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a block diagram of a self generating universal AC/DC motor and DC generator assembly with a supplemental source of energy in accordance with the principles of the invention.

### DESCRIPTION OF THE PREFERRED EMBODIMENT

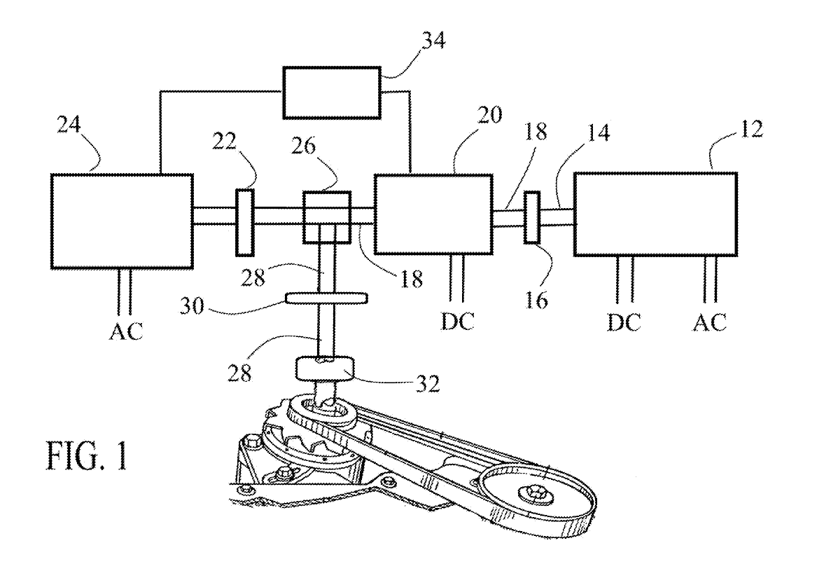

Referring to FIG. 1, there is disclosed a block diagram of a self generating universal AC/DC motor and DC generator assembly with a supplemental source of energy in accordance with the principles of the invention.

A series-wound motor is referred to as a universal motor when it has been designed to operate on either AC or DC power. The ability to operate on AC is because the current in both the field and the armature (and hence the resultant magnetic fields) will alternate (reverse polarity) in synchronism, and hence the resulting mechanical force will occur in a constant direction.

Universal motors are the traction motors which are used in electric rail road cars with an AC frequency of 25 hertz or lower. Because they are universal motors, the locomotives are capable of operating from a third rail or an overhead line that carries DC current. An advantage of the universal motor is that AC supplies may be used on motors which have some characteristics more common with DC motors, specifically high starting torque and very compact design if high running speeds are used. Continuous speed control of a universal motor running on AC is easily obtained with a thyristor circuit.

Continuing with FIG. 1, a 120 volt universal motor 12, which can operate with either AC power or DC power, has a rotatable shaft 14 that is directly connected via coupling 16 to one end of rotatable shaft 18 of DC generator 20 where the other end of shaft 18 extends out from the other side of the generator. and is connected thru an electrically operated engage-disengage clutch 22 to a 120 volt AC motor 24 which may be a universal motor. Located between generator 20 and engage-disengage clutch 22 is a power transfer coupling 26 which mechanically connects a power take-off shaft 28 to shaft 18 of the generator.

An electrically operated engage-disengage clutch 30, which is connected to shaft 28, selectively connects the output of rotatable shaft 28 to a take-off coupling 32 which is adapted to be connected to a device which receives power from a rotating shaft. A speed controller 34 is located between generator 20 and AC motor 24. Generator 20 is designed to produce a DC current having a potential of 120 volt which is fed to the DC input terminals of universal motor 12 as an input voltage. It is understood, however, that the generator is not limited to generating a potential of 120 volts, but can generate any potential that is equal to the operating potential of universal motor 12.

In operation, an AC voltage of, for example, 120 volts is fed to the AC terminals of motor 12 which causes shaft 14 of motor 12 to rotate. Shaft 14, acting thru coupling 16 causes shaft 18 of generator 20 to rotate. As the shaft of generator comes up to speed, DC power from generator 20 is fed to operate motor 12. Generator shaft 18 is coupled to an AC motor 24 through electrically operated clutch 22, and speed controller 34 is located between generator 20 and motor 24. At some predetermined time before generator 20 generates its full output potential of 120 volts, or when the output potential of the generator reaches a potential which is less than its full potential, AC power to motor 12 is discontinued and motor 24 is energized to bring generator 20 up to full speed to generate its rated potential. Speed controller 34 is provided to controllably activate motor 24 to insure that generator operates at full speed and generates its full power to operate motor 12.

Thus, during operation and after start up, AC power is no longer being fed to universal motor 12. It is powered by the output of generator 20. When, however, during operation the output power of the generator which is being fed to the motor is less than what is needed by the motor to allow the motor to drive the generator at its rated speed, speed controller activates motor 24 to bring the generator shaft up to rated speed thus increasing the output of the generator. Instances which can cause the generator to loose speed can be a sudden load applied to the generator shaft such as a device being connected to take off coupling 32, loss of efficiency of the motor 12 or the generator 20, increased frictional losses, etc.

It is understood that there can be instances when operational losses may prevent the motor-generator assembly from reaching rated speed and/or output. During these times AC motor 24 can be operated as a source of energy to provide the necessary required power to bring the motor-generator assembly up to speed.

While there have been shown and described and pointed out the fundamental novel features of the invention as applied to the preferred embodiment, it will be understood that the foregoing is considered as illustrative only of the principles of the invention and not intended to be exhaustive or to limit the invention to the precise forms disclosed. Obvious modifications or variations are possible in light of the above teachings. The embodiment discussed was chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A self generating motor-generator assembly comprising:
a universal motor having AC input terminals and DC input terminals;
a generator having a shaft mechanically coupled to said universal motor to generate a DC potential which is fed to the DC input terminals of said universal motor to cause said universal motor to rotate said generator shaft; and
a second motor mechanically coupled to said generator shaft to increase the speed of said generator to its rated speed when said universal motor does not urge the shaft of said generator to rotate at its rated speed.

2. The assembly of claim 1 wherein AC power is supplied to the AC terminals of said universal motor to initiate operation of said universal motor and said generator.

3. The assembly of claim 2 wherein operation of said second motor is initiated in the event that said generator does not reach its rated speed within a predetermined interval of time.

4. The assembly of claim 3 wherein AC power to said AC terminals of said universal motor is turned off when said generator reaches its rated speed or when said second motor starts to operate.

5. The assembly of claim 4 wherein a speed controller is coupled between said generator and said second motor to initiate operation of said second motor when the speed of said generator is below its rated speed.

6. The assembly of claim 5 wherein a first clutch is located between the generator and the second motor to couple the second motor to the generator.

7. The assembly of claim 6 wherein said first clutch couples said second motor to said generator when said second motor is energized.

8. The assembly of claim 7 wherein said universal motor is coupled to said generator with a common shaft.

9. The assembly of claim 8 wherein the shaft of the generator has one end coupled to the universal motor and a second end that is coupled to said first clutch.

10. The assembly of claim 9 wherein a power transfer coupling is connected to the generator shaft between said generator and said first clutch.

11. The assembly of claim 10 wherein a power take-off shaft is coupled to the power transfer coupling for providing power in the form of a rotating shaft.

12. The assembly of claim 11 wherein a power take-off coupling is attached to an end of the power take-off shaft.

13. The assembly of claim 12 wherein a second clutch is coupled to said power take-off shaft between said power take-off coupling and said power transfer coupling.

14. The assembly of claim 13 wherein the second clutch controllably connects the power take-off coupling attached to an end of the power take-off shaft to the power transfer coupling.

15. A method of operating a self generating motor-generator assembly comprises:
providing a universal motor having AC input terminals and DC input terminals;
providing a generator having a shaft mechanically coupled to said universal motor to generate a DC potential which is fed to the DC input terminals of said universal motor to cause said universal motor to rotate said generator shaft; and
providing a second motor mechanically coupled to said generator shaft to increase the speed of said generator to its rated speed when said universal motor does not urge the shaft of said generator to rotate at its rated speed.

16. The method of 15 wherein AC power is supplied to the AC terminals of said universal motor to initiate operation of said universal motor and said generator.

17. The method of claim 16 wherein operation of said second motor is initiated in the event that said generator does not reach its rated speed within a predetermined interval of time.

18. The method of claim 17 wherein AC power to said AC terminals of said universal motor is turned off when said generator reaches its rated speed or when said second motor starts to operate.

19. The method of claim 18 wherein a speed controller is coupled between said generator and said second motor to initiate operation of said second motor when the speed of said generator is below its rated speed.

20. The method of claim 19 wherein a first clutch is located between the generator and the second motor to couple the second motor to the generator.
